(19) United States
(12) Patent Application Publication
(10) Pub. No.: US 2021/0365854 A1
(43) Pub. Date: Nov. 25, 2021

(54) PROBABILISTIC OPTIMIZATION FOR TESTING EFFICIENCY

(71) Applicant: Optum, Inc., Minnetonka, MN (US)

(72) Inventors: Gregory J. Boss, Saginaw, MI (US); Jon Kevin Muse, Thompsons Station, TN (US); Rama S. Ravindranathan, Edison, NJ (US); Damian Kelly, Kilcock Kildare (IE)

(21) Appl. No.: 17/025,311

(22) Filed: Sep. 18, 2020

Related U.S. Application Data
(60) Provisional application No. 63/026,825, filed on May 19, 2020.

(51) Int. Cl. G06Q 10/06

(52) U.S. Cl. CPC G06Q 10/0635

(57) ABSTRACT

There is a need for more reliable and efficient performing predictive data analysis to generate optimal testing arrangements. This need can be addressed by, for example, solutions for performing for probabilistic testing optimization. In one example, a method includes identifying agent activity data for a plurality of monitored agent profiles; determining, based at least in part on the agent activity data, a plurality of monitored agent clusters; determining, based at least in part on the agent activity data and the plurality of monitored agent clusters, a per-agent risk score for each monitored agent profile; for each monitored agent cluster, determining a per-cluster risk score based at least in part on each per-agent risk score for the monitored agent cluster; selecting a predefined number of target agent profiles in accordance with a testing optimization policy; and enabling access to output data describing the predefined number of target agent profiles in order to facilitate performing one or more testing operations.

### CROSS-REFERENCES TO RELATED APPLICATIONS

The present application claims priority to U.S. Provisional Patent Application No. 63/026,825, filed on May 19, 2020, which is incorporated herein by reference in its entirety.

### BACKGROUND

Various embodiments of the present invention address technical challenges related to performing predictive data analysis to generate optimal testing arrangements. Various embodiments of the present invention disclose various techniques for efficiently and reliably performing predictive data analysis to generate optimal testing arrangements.

### BRIEF SUMMARY

In general, embodiments of the present invention provide methods, apparatus, systems, computing devices, computing entities, and/or the like for performing predictive data analysis to generate optimal testing arrangements, such as performing predictive data analysis to generate optimal testing arrangements using testing optimization policies characterized by testing optimization policy objectives such exploration-exploration objectives, cluster count maximization objectives, and agent cluster connectivity maximization objectives; using agent activity data used to infer connectivity graphs and graph embeddings that may in turn be used to generate optimal testing arrangements; and/or the like.

In accordance with one aspect, a method is provided. In one embodiment, the method comprises: identifying agent activity data for the plurality of monitored agent profiles; determining, based at least in part on the agent activity data, a plurality of monitored agent clusters, wherein each monitored agent cluster of a plurality of monitored agent clusters comprises an interactive subset of the plurality of monitored agent profiles; determining, based at least in part on the agent activity data and the plurality of monitored agent clusters, a per-agent risk score for each monitored agent profile of the plurality of monitored agent profiles; for each monitored agent cluster of the plurality of monitored agent clusters, determining a per-cluster risk score based at least in part on each per-agent risk score for a monitored agent profile of the plurality of monitored agent profiles that is in the interactive subset for the monitored agent cluster; selecting a predefined number of target agent profiles of the plurality of monitored agent profiles in accordance with a testing optimization policy, wherein: (i) the test optimization policy is characterized by one or more test optimization policy objectives that comprise an exploitation-exploitation objective, (ii) the exploitation-exploitation objective is configured to recommend selecting the predefined number of target agent profiles from an exploration subset of the plurality of monitored agent profiles and an exploitation subset of the plurality of monitored agent profiles, (iii) the exploration subset of the plurality of monitored agent profiles comprises a low risk cluster subset of the plurality of monitored agent profiles that are associated with a low score subset of the plurality of monitored agent clusters having a low per-cluster risk score, and (iv) the exploitation subset of subset of the plurality of monitored agent profiles comprises a high risk cluster subset of the plurality of monitored agent profiles that are associated with a high score subset of the plurality of monitored agent clusters having a high per-cluster risk score; and enabling access to output data describing the predefined number of target agent profiles in order to facilitate performing one or more testing operations.

In accordance with another aspect, a computer program product is provided. The computer program product may comprise at least one computer-readable storage medium having computer-readable program code portions stored therein, the computer-readable program code portions comprising executable portions configured to: identify agent activity data for the plurality of monitored agent profiles; determine, based at least in part on the agent activity data, a plurality of monitored agent clusters, wherein each monitored agent cluster of a plurality of monitored agent clusters comprises an interactive subset of the plurality of monitored agent profiles; determining, based at least in part on the agent activity data and the plurality of monitored agent clusters, a per-agent risk score for each monitored agent profile of the plurality of monitored agent profiles; for each monitored agent cluster of the plurality of monitored agent clusters, determine a per-cluster risk score based at least in part on each per-agent risk score for a monitored agent profile of the plurality of monitored agent profiles that is in the interactive subset for the monitored agent cluster; selecting a predefined number of target agent profiles of the plurality of monitored agent profiles in accordance with a testing optimization policy, wherein: (i) the test optimization policy is characterized by one or more test optimization policy objectives that comprise an exploitation-exploitation objective, (ii) the exploitation-exploitation objective is configured to recommend selecting the predefined number of target agent profiles from an exploration subset of the plurality of monitored agent profiles and an exploitation subset of the plurality of monitored agent profiles, (iii) the exploration subset of the plurality of monitored agent profiles comprises a low risk cluster subset of the plurality of monitored agent profiles that are associated with a low score subset of the plurality of monitored agent clusters having a low per-cluster risk score, and (iv) the exploitation subset of subset of the plurality of monitored agent profiles comprises a high risk cluster subset of the plurality of monitored agent profiles that are associated with a high score subset of the plurality of monitored agent clusters having a high per-cluster risk score; and enable access to output data describing the predefined number of target agent profiles in order to facilitate performing one or more testing operations.

In accordance with yet another aspect, an apparatus comprising at least one processor and at least one memory including computer program code is provided. In one embodiment, the at least one memory and the computer program code may be configured to, with the processor, cause the apparatus to: identify agent activity data for the plurality of monitored agent profiles; determine, based at least in part on the agent activity data, a plurality of monitored agent clusters, wherein each monitored agent cluster of a plurality of monitored agent clusters comprises an interactive subset of the plurality of monitored agent profiles; determining, based at least in part on the agent activity data and the plurality of monitored agent clusters, a per-agent risk score for each monitored agent profile of the plurality of monitored agent profiles; for each monitored agent cluster of the plurality of monitored agent clusters, determine a per-cluster risk score based at least in part on each per-agent risk score for a monitored agent profile of the plurality of monitored agent profiles that is in the interactive subset for the monitored agent cluster; selecting a predefined number of target agent profiles of the plurality of monitored agent profiles in accordance with a testing optimization policy, wherein: (i) the test optimization policy is characterized by one or more test optimization policy objectives that comprise an exploitation-exploitation objective, (ii) the exploitation-exploitation objective is configured to recommend selecting the predefined number of target agent profiles from an exploration subset of the plurality of monitored agent profiles and an exploitation subset of the plurality of monitored agent profiles, (iii) the exploration subset of the plurality of monitored agent profiles comprises a low risk cluster subset of the plurality of monitored agent profiles that are associated with a low score subset of the plurality of monitored agent clusters having a low per-cluster risk score, and (iv) the exploitation subset of subset of the plurality of monitored agent profiles comprises a high risk cluster subset of the plurality of monitored agent profiles that are associated with a high score subset of the plurality of monitored agent clusters having a high per-cluster risk score; and enable access to output data describing the predefined number of target agent profiles in order to facilitate performing one or more testing operations.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example external computing entity in accordance with some embodiments discussed herein.

FIG. 4 is a flowchart diagram of an example process for performing probabilistic testing optimization with respect to a plurality of monitored agent profiles in accordance with some embodiments discussed herein.

FIG. 5 provides an operational example of generating monitored agent clusters in accordance with some embodiments discussed herein.

FIG. 6 provides an operational example of generating graph embeddings for monitored target entities associated with a connectivity graph in accordance with some embodiments discussed herein.

FIG. 7 is a flowchart diagram of an example process for selecting target agent profiles in accordance with a testing optimization policy that is solely characterized by an exploration-exploitation objective in accordance with some embodiments discussed herein.

FIG. 8 is a flowchart diagram of an example process for selecting target agent profiles in accordance with a testing optimization policy that is solely characterized by an agent cluster connectivity maximization objective in accordance with some embodiments discussed herein.

FIG. 9 provides an operational example of selecting target agent profiles during a first iteration of a testing efficiency optimization routine in accordance with some embodiments discussed herein.

FIG. 10 provides an operational example of updating per-agent risk scores during a first iteration of a testing efficiency optimization routine in accordance with some embodiments discussed herein.

FIG. 11 provides an operational example of selecting target agent profiles during a second iteration of a testing efficiency optimization routine in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. OVERVIEW

One technologically advantageous aspect of various embodiments of the present invention relates to utilizing clustering techniques to extrapolate risk factors across groups of monitored agent profiles and determine optimal test targets. For example, in some embodiments, a predictive data analysis computing entity aggregates per-agent risk scores on a cluster level in order to generate per-cluster risk scores, and then uses per-cluster risk scores in accordance with testing optimization policies that are defined based at least in part on per-cluster risk scores in order to filter monitored agent profiles and select target agent profiles. Selecting target agent profiles based at least in part on cluster-level features, as opposed to agent-level features, is likely to be computationally efficient, as the number of clusters is expected to be substantially less than the number of monitored agent profiles. Accordingly, by introducing techniques for utilizing clustering techniques to extrapolate risk factors across groups of monitored agent profiles, various embodiments of the present invention improve the computational efficiency of performing predictive data analysis in order to select optimal test targets.

Another technologically advantageous aspect of various embodiments of the present invention relates to utilizing graph embeddings derived from a connectivity graph in order to determine per-agent risk scores for monitored target agents. Experimental results have shown that: (i) graph embeddings will provide a more storage-wise efficient technique for storing complex connectivity graph properties compared to naïve graph encoding techniques that store all of the data associated with a complex connectivity graph, and (ii) performing predictive data analysis using graph embeddings is more computationally efficient than performing conventional graph-based predictive data analysis solutions that rely on non-embedded graph data. Accordingly, by introducing techniques for utilizing graph embeddings derived from a connectivity graph in order to determine per-agent risk scores for monitored target agents, various embodiments of the present invention improve both the computational efficiency as well as the storage-wise efficiency of performing predictive data analysis in order to select optimal test targets.

Various embodiments of the present invention provide techniques for optimizing test efficiency given a limited number of available tests, techniques which may be particularly advantageous during a pandemic. Currently, when the number of tests are limited, health professionals generally reserve testing for patients that are already exhibiting severe symptoms. When testing is distributed in this fashion there is no way to anticipate which locations will have higher infection rates than the others. When test supplies are limited, clinicians are forced to make decisions of test administration only to those patients with severe symptoms. This causes disease progression hotspots to show up without warranty and also introduces extreme burdens on the healthcare system. In response, embodiments of the present invention are configured identify and target individuals who if tested will reveal more data than administering tests on a speculative or random basis. According to some embodiments, a proposed system enables better predictability and verification of a population's exposure to a virus or highly communicative disease by determining the most predictive sample of individuals that provide the most accurate data relative to an exposure risk. Embodiments of the present invention will allow the least amount of testing materials to be expended while maximizing the likelihood of discovering impacted individuals when analyzing a target area, thus saving resources and also identifying the possibility of more precise channeling of medical personnel, test kits, and/or the like.

### II. DEFINITIONS

The term “monitored agent profile” may refer to a data construct that is configured to describe an individual in a monitored population space, where the interactions of the individual with other individuals and/or with clusters of individuals are captured via agent activity data for the individual, and where the captured interactions may be used to generate a per-agent risk score for the noted individual. Examples of monitored agent profiles include agent profiles associated with particular end users of consumer device data, particular end users of Internet of Things (IoT) devices, particular end users of wearable devices, particular members of medical claims databases, particular members of individual metadata databases, and/or the like. In some embodiments, each monitored agent profile may describe associations of a correspondent individual across two or more agent activity data sources. For example, a particular monitored agent profile may describe that an agent profile A is associated with a particular smartphone device, a particular wearable device, and a particular profile in a given individual metadata database.

The term “agent activity data” may refer to a data construct that is configured to describe activities and/or relationships of one or more monitored agent profiles. Examples of agent activity data include individual location data (e.g., end user location data transmitted by a consumer device having global positioning system (GPS) capabilities, end user location data described by cellular data records, end user proximity data transmitted by track and trace applications, and/or the like), individual medical claim submission data, individual group scheme membership data (e.g., family membership metadata for an individual), and/or the like. Examples of techniques for capturing agent activity data include one or more of the following: (i) electronic capture of location data through a tracking app or a GPS-enabled app like Google Maps, (ii) electronic capture of anonymous data related to individuals, (iii) capturing of data describing proximity of individuals to each other, (iv) capturing of data describing proximity of individuals to particular locations (e.g., restaurants, schools, playgrounds, civic centers, and/or the like), (v) capturing of population location data over time by network providers (e.g., via cellular network call detail records), and (vi) capturing of Bluetooth data which can describe proximity of individuals to each other.

The term “connectivity graph” may refer to a data object that is configured to describe estimated/detected interactions/connections between a group of monitored agent profiles based at least in part on agent activity data for the group of monitored agent profiles. For example, a connectivity graph may describe that two agent activity profiles have likely been proximate to each other as described by the agent activity data for the two agent activity profiles. As another example, a connectivity graph may describe that two or more agent activity profiles have likely all visited (e.g., with an above-threshold visitation frequency) a particular location contemporaneously, where the contemptuousness of a visit may be determined based at least in part on an estimated environmental staying power of a target condition/disease/virus in the air given the openness of the environmental condition of the particular location. As yet another example, a connectivity graph may describe that two agent profiles are deemed to have had indirect interactions even though they have not likely had direct interactions because the two agent profiles have each had direct substantial interactions with a common third agent profile. Thus, in some embodiments, the interactions described by a connectivity graph may include substantial indirect interactions as well as substantial direct interactions between a group of individuals, where the significance of inter-agent interactions between two or more agent profiles may be determined based at least in part on estimated disease propagation requirements of a target condition/disease/virus.

The term “monitored agent cluster” may refer to a data construct that is configured to describe a group of monitored agent profiles deemed to have significant (e.g., above-threshold) interactions between them. Monitored agent clusters may be determined based at least in part on graph concentrations of monitored agents by location over time. For example, a monitored agent cluster may describe a group of monitored agent profiles that are deemed to have high levels of interactions among them. As another example, a monitored agent cluster may describe a group of monitored agent profiles that have significant contemporaneous interactions with a common path/location. In some embodiments, monitored agent clusters are determined based at least in part on agent groupings, where the agent groupings may be determined based at least in part on common associations with most utilized clusters or utilize subsets of agents that represent the entirety of clusters, and where the noted common associations may for example be determined in accordance with travel data (including public transportation data), traffic hotspot data, transactional data, direct contact data, facility utilization data, and/or the like.

The term “per-agent risk score” may refer to a data object that is configured to describe a likelihood that a corresponding monitored agent profile suffers from a target condition/disease/virus. The per-agent risk score for a corresponding monitored agent profile may be determined based at least in part on the historical test outcome data for the monitored agent profile and/or the interactivity data for the monitored agent profile, where the historical test outcome data may describe whether the monitored agent profile has tested positive within a recent time period (e.g., where the recent time period may be determined based at least in part on an antibody strength period of the target condition/disease virus), and where the interactivity data may describe a level of interaction/connection of the monitored agent profile with one or more other monitored agent profiles and/or one or more monitored agent clusters. For example, in some embodiments, the occurrence of any of the following conditions may lead to an increase in the per-agent risk score for a monitored agent profile: (i) detection of visitation of a medical provider location with high infection prevalence by the monitored agent profile as described by the agent activity data for the monitored agent profile, (ii) detection of visitation of a location with high infection prevalence by the monitored agent profile as described by the agent activity data for the monitored agent profile, (iii) detection of connection (e.g., direct physical proximity) of the monitored agent profile with another agent profile deemed infected profile as described by the agent activity data for the monitored agent profile, (iv) detection of utilization of public transportation by the monitored agent profile as described by the agent activity data for the monitored agent profile, (v) detection of presence of the monitored agent profile within a predefined proximity of a travel hotspot as described by the agent activity data for the monitored agent profile, and (vi) diagnosis of the monitored agent profile as infected (which may, in some embodiments, set the per-agent risk score for the monitored agent profile to a maximal risk score value, such as a risk probability score value of one). As another example, in some embodiments, a negative test result for the monitored agent profile may decrease the per-agent risk score for the monitored agent profile.

The term “graph embedding” may refer to a data object that is configured to describe one or more interaction intensity measures of a corresponding target agent profile as determined based at least in part on a connectivity graph that describes the interactions/connections of the corresponding target agent profile, where the interaction intensity measures may be defined/articulated with respect to a multi-dimensional embedding space. For example, a particular multi-dimensional embedding space may have a first dimension that describes an intensity of interaction/connection of monitored target agent profiles with infected monitored target agent profiles and/or with monitored target agent profiles having above-threshold per-agent risk scores, a second dimension describing an intensity of association of monitored target agent profiles with monitored agent clusters deemed to have an above-threshold number/ratio of infected monitored target agent profiles and/or with monitored agent clusters deemed to have an above-threshold number of monitored target agent profiles having above-threshold per-agent risk scores, a third dimension describing interaction intensity of monitored target agent profiles with traffic hotspots, and/or the like. In the noted example, the graph embedding for a particular monitored agent profile may be a vector that includes a first vector value describing an intensity of interaction/connection of the particular monitored target agent profile with infected monitored target agent profiles and/or with monitored target agent profiles having above-threshold per-agent risk scores, a second vector value describing an intensity of association of the particular monitored target agent profile with monitored agent clusters deemed to have an above-threshold number/ratio of infected monitored target agent profiles and/or with monitored agent clusters deemed to have an above-threshold number of monitored target agent profiles having above-threshold per-agent risk scores, a third vector value describing the interaction intensity of the particular monitored target agent profile with traffic hotspots, and/or the like. In some embodiments, to generate graph embeddings for a group of monitored agent profiles, a computing entity may process a connectivity graph for the group of monitored agent profiles using one or more graph processing algorithms, such as a random walk graph processing algorithm, a DeepWalk graph processing algorithm, a Node2Vec graph processing algorithm, a Graph2Vec graph processing algorithm, a Graph Embedding with Self Clustering (GEMSEC) graph processing algorithm, and/or the like.

The term “test optimization policy” may refer to a data construct that is configured to describe one or more desired utility objectives for selecting target agent profiles, where a target agent profile is a target agent profile that has been selected for testing and whose testing outcome has been predicted to provide significant insights that can increase reliability of inferred population-wide per-agent risk scores across an overall population of monitored agent profiles. Examples of objectives for the test optimization policy are described below; however, a person of ordinary skill in the relevant technology will recognize that other such test optimization policy objectives may be desired/recommended. Moreover, when having more than one objective for selecting target agent profiles, the test optimization policy may specify guidelines/operations that are configured to define a tradeoff policy for balancing the objectives against each other, such as weights for each objective and/or operations configured to construct a multi-dimensional optimization measure that can then be optimized using a numerical optimization method in order to select a group of target agent profiles based at least in part on the various test optimization policy objectives.

The term “cluster maximization policy” may refer to a data construct that is configured to describe a test optimization policy objective that is in turn configured to recommend selecting one or more target agent profiles in a manner that maximizes a count of a related subset of the plurality of monitored agent clusters that are associated with the one or more target agent profiles. In other words, in accordance with the cluster maximization objective, a predictive data analysis computing entity should maximize the number of tested monitored agent clusters, where a monitored agent cluster is deemed tested if at least one monitored agent profile in the interactive subset for the monitored agent cluster (e.g., at least one monitored agent profile that is deemed to be associated with the monitored agent cluster) is selected as a target agent profile. For example, if the cluster maximization objective is the sole objective for a test optimization policy, and further if a predictive data analysis computing entity is configured to select three target agent profiles, and further if there are a total of four monitored agent clusters, the predictive data analysis computing entity may apply the test optimization policy to select at least one monitored agent profile from each of three of the four monitored agent clusters. As another example, if the cluster maximization objective is the sole objective for a test optimization policy, and further if a predictive data analysis computing entity is configured to select five target agent profiles, and further if there are a total of four monitored agent clusters, the predictive data analysis computing entity computing entity may apply the test optimization policy to select at least one monitored agent profile from each of the four monitored agent clusters.

The term “exploration-exploitation policy” may refer to a data construct that is configured to describe a test optimization policy objective that is in turn configured to recommend selecting target agent profiles from an exploration subset of the plurality of monitored agent profiles and an exploitation subset of the plurality of monitored agent profiles, where the exploration subset of the plurality of monitored agent profiles comprises a low risk cluster subset of the plurality of monitored agent profiles that are associated with a low score subset of the plurality of monitored agent clusters having a low per-cluster risk score, and the exploitation subset of subset of the plurality of monitored agent profiles comprises a high risk cluster subset of the plurality of monitored agent profiles that are associated with a high score subset of the plurality of monitored agent clusters having a high per-cluster risk score. For example, if the exploration-exploitation objective is the sole objective for a test optimization policy, and if the exploration-exploitation objective requires selecting forty percent of target agent profiles from the exploration subset and sixty percent of target agent profiles from the exploitation subset, and further if a predictive data analysis computing entity is configured to select ten target agent profiles, then the predictive data analysis computing entity may apply the test optimization policy to select four target agent profiles from the exploitation subset and six target agent profiles from the exploitation subset.

The term “agent cluster connectivity maximization objective” may refer to a data construct that is configured to describe a test optimization policy objective that is in turn configured to recommend selecting target agent profiles based at least in part on a high connectivity subset of the plurality of the plurality of monitored agent profiles having a high cluster connectivity score. The goal of an agent cluster connectivity maximization objective may be to test individuals that have the highest levels of interactions across various clusters and are thus likely to, if infected, infect a higher number of individuals in a higher number of clusters. An example of a person that may be selected according to an agent cluster connectivity maximization objective is a person who is a frequent shopper, a frequent gym participant, and a frequent public transportation user.

The term “per-cluster risk score” may refer to a data construct that is configured to describe a relative measure of estimated prevalence of a target condition/disease/virus among a corresponding monitored agent cluster. The per-cluster risk score for a corresponding monitored agent cluster may be determined based at least in part on the per-agent risk score for each monitored agent profile that is in the interactive subset for the corresponding monitored agent cluster, as well as optionally any other information about susceptibility of the corresponding monitored agent cluster to spreading a disease (such as, for example, information about how much of a traffic hotspot a location associated with the corresponding monitored agent cluster is). For example, in some embodiments, given a monitored agent cluster that is associated with one hundred monitored target agents, the per-cluster risk score for the monitored agent cluster may be determined based at least in part on each per-agent risk score for each of the one hundred monitored agent profiles that are in the interaction subset for the monitored agent cluster. In some embodiments, per-cluster risk scores for a cluster of monitored agent profiles can be used to determine an exploration subset of the group of monitored agent profiles and an exploration subset of the group of monitored agent profiles, where the exploration subset of the group of monitored agent profiles may describe each monitored agent profile in the group of monitored agent profiles that is in the interaction subset for a low score subset of the group of monitored agent clusters having a low (e.g., below a lower threshold, a lower-bound outlier, and/or the like) per-cluster risk score, and where the exploitation subset of the group of monitored agent profiles may describe each monitored agent profile in the group of monitored agent profiles that is in the interaction subset for a high score subset of the group of monitored agent clusters having a high (e.g., above a lower threshold, an upper-bound outlier, and/or the like) per-cluster risk score.

The term “cluster connectivity score” may refer to a data construct that describes a measure of a count of monitored agent clusters that a particular monitored agent profile has been in contact with. Thus, accordingly, an example of a person that may have a relatively high cluster connectivity score may be an individual who is a frequent shopper, a frequent gym participant, and a frequent public transportation user.

The term “test availability hyper-parameter” may refer to a data construct that is configured to describe available number of tests for a particular target condition/disease/virus at a point in time. In some embodiments, the predefined number of selected testing targets may be selected in accordance with a test optimization policy that is configured to maximize an expected predictive utility of tests performed on members of an overall population in accordance with the constraints imposed by the availability of tests as described by the test availability parameter. Such constrained optimization features may be specially beneficial in deciding test administration during a pandemic.

### III. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

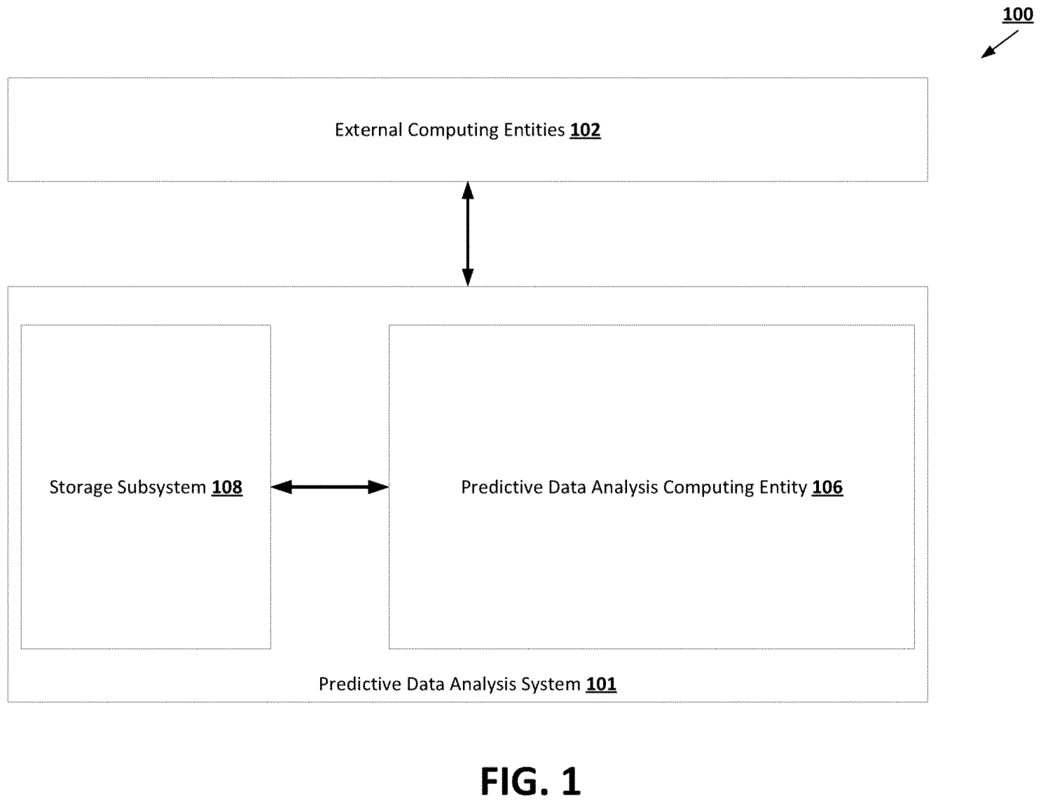

FIG. 1 is a schematic diagram of an example architecture 100 for performing predictive data analysis. The architecture 100 includes a predictive data analysis system 101 configured to receive predictive data analysis requests from external computing entities 102, process the predictive data analysis requests to generate predictions, provide the generated predictions to the external computing entities 102, and automatically perform prediction-based actions based at least in part on the generated predictions. An example of a prediction that can be generated using the predictive data analysis system 101 is a prediction about optimal test targets in order to facilitate testing for a target condition/disease/virus.

In some embodiments, predictive data analysis system 101 may communicate with at least one of the external computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more external computing entities 102, process the predictive data analysis requests to generate predictions corresponding to the predictive data analysis requests, provide the generated predictions to the external computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

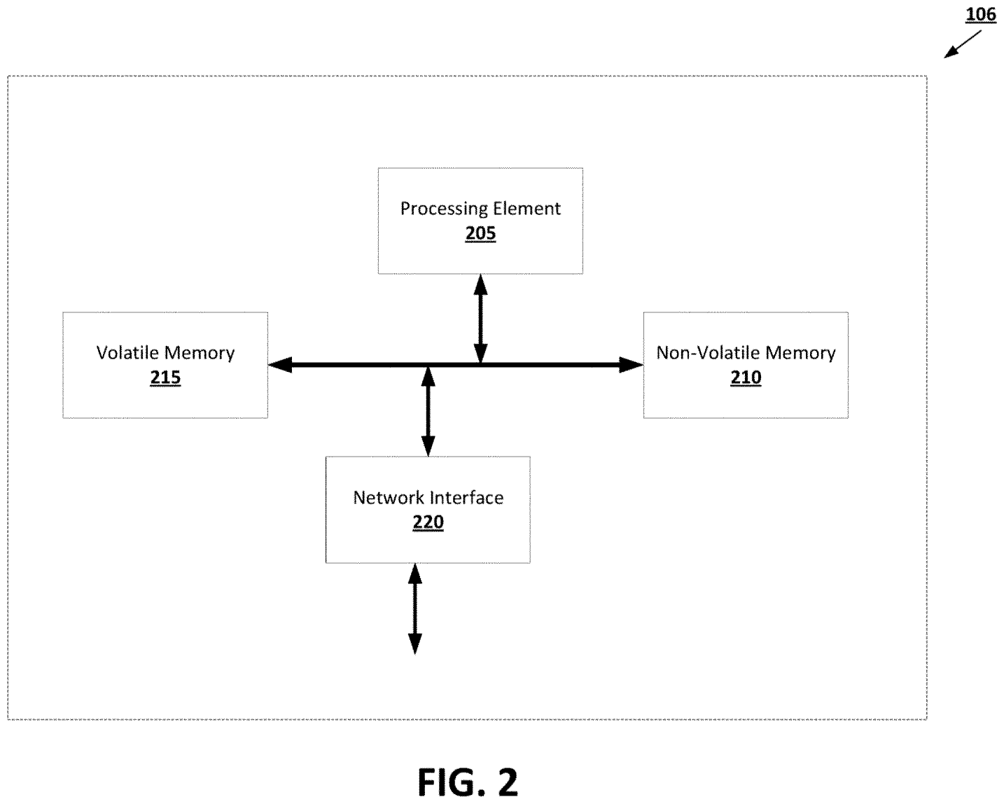

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary External Computing Entity

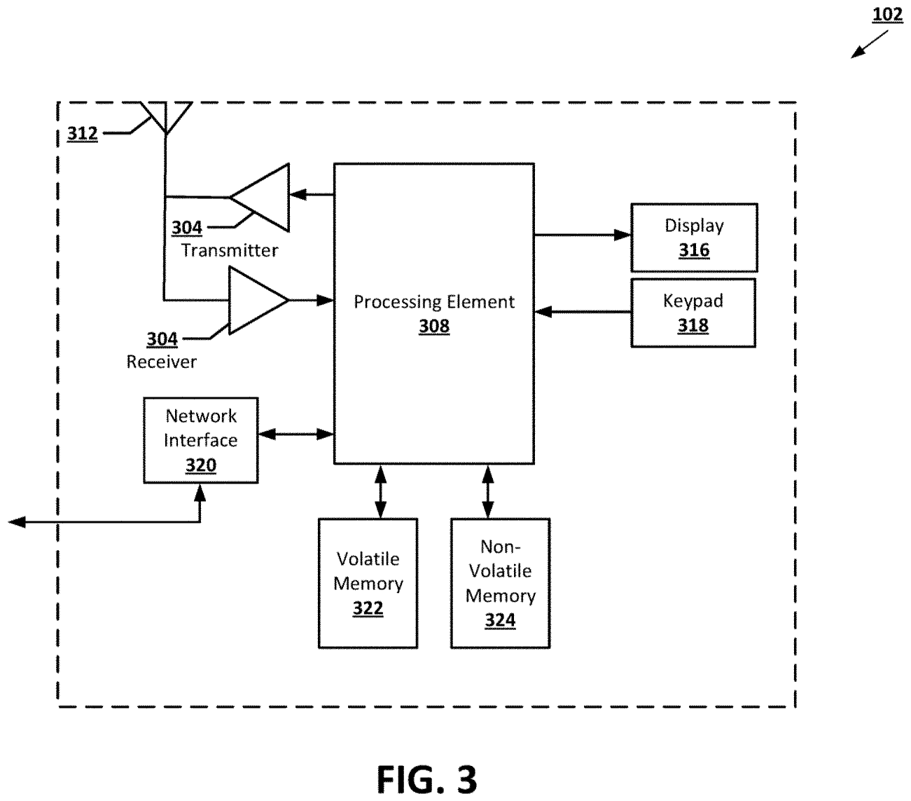

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. External computing entities 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the predictive data analysis computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the predictive data analysis computing entity 106 via a network interface 320.

Via these communication standards and protocols, the external computing entity 102 can communicate with various other entities using concepts such as Unstructured Supplementary Service Data (USSD), Short Message Service (SMS), Multimedia Messaging Service (MIMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the predictive data analysis computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the predictive data analysis computing entity 106 and/or various other computing entities.

In another embodiment, the external computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the external computing entity 102 may be embodied as an artificial intelligence (AI) computing entity, such as an Amazon Echo, Amazon Echo Dot, Amazon Show, Google Home, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. EXEMPLARY SYSTEM OPERATIONS

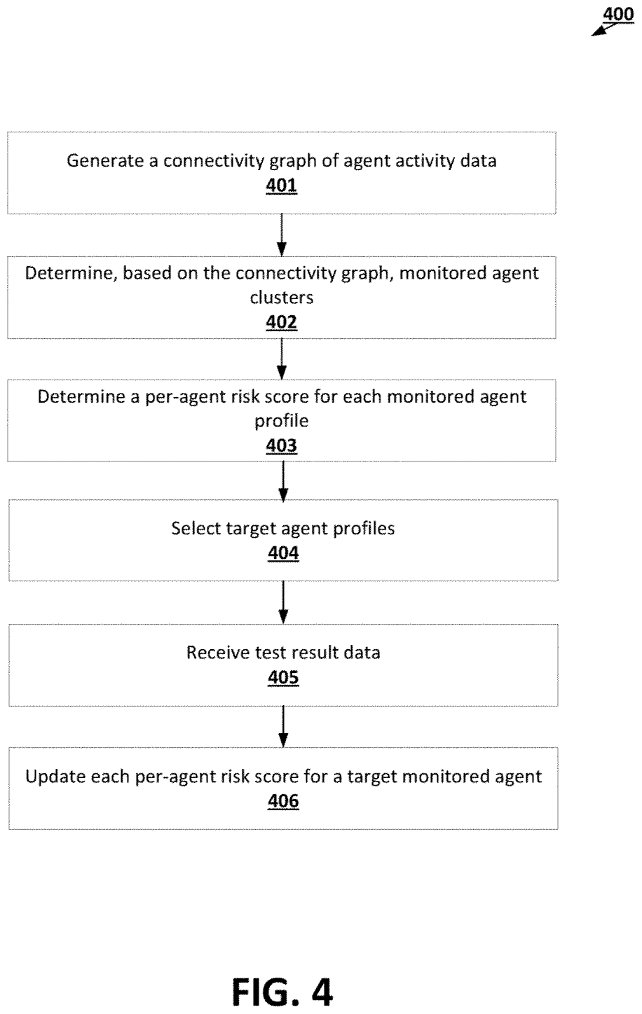

FIG. 4 is a flowchart diagram of an example process 400 for probabilistic testing optimization with respect to a plurality of monitored agent profiles. Via the various steps/operations of the process 400, the predictive data analysis computing entity 106 can utilize efficient and reliable interactive clustering algorithms to make test administration processes more efficient and more reliable.

The process 400 begins at step/operation 401 when the predictive data analysis computing entity 106 generates a connectivity graph of agent activity data for the plurality of monitored agent profiles. To do so, the predictive data analysis computing entity 106 may receive agent activity data from one or more agent activity data sources and utilize the agent activity data to generate the connectivity graph.

In general, a monitored agent profile describes an individual in a monitored population space, where the interactions of the individual with other individuals and/or with clusters of individuals are captured via agent activity data for the individual, and where the captured interactions may be used to generate a per-agent risk score for the noted individual. Examples of monitored agent profiles include agent profiles associated with particular end users of consumer device data, particular end users of Internet of Things (IoT) devices, particular end users of wearable devices, particular members of medical claims databases, particular members of individual metadata databases, and/or the like. In some embodiments, each monitored agent profile may describe associations of a correspondent individual across two or more agent activity data sources. For example, a particular monitored agent profile may describe that an agent profile A is associated with a particular smartphone device, a particular wearable device, and a particular profile in an individual metadata database.

Agent activity data may describe activities and/or relationships of one or more monitored agent profiles. Examples of agent activity data include individual location data (e.g., end user location data transmitted by a consumer device having global positioning system (GPS) capabilities, end user location data described by cellular data records, end user proximity data transmitted by track and trace applications, and/or the like), individual medical claim submission data, individual group scheme membership data (e.g., family membership metadata for an individual), and/or the like. Examples of techniques for capturing agent activity data include one or more of the following: (i) electronic capture of location data through a tracking app or a GPS-enabled app like Google Maps, (ii) electronic capture of anonymous data related to individuals, (iii) capturing of data describing proximity of individuals to each other, (iv) capturing of data describing proximity of individuals to particular locations (e.g., restaurants, schools, playgrounds, civic centers, and/or the like), (v) capturing of population location data over time by network providers (e.g., via cellular network call detail records), and (vi) capturing of Bluetooth data which can describe proximity of individuals to each other.

A connectivity graph may describe estimated/detected interactions/connections between a group of monitored agent profiles based at least in part on agent activity data for the group of monitored agent profiles. For example, a connectivity graph may describe that two agent activity profiles have likely been proximate to each other as described by the agent activity data for the two agent activity profiles. As another example, a connectivity graph may describe that two or more agent activity profiles have likely all visited (e.g., with an above-threshold visitation frequency) a particular location contemporaneously, where the contemptuousness of a visit may be determined based at least in part on an estimated environmental staying power of a target condition/disease/virus in the air given the openness of the environmental condition of the particular location. As yet another example, a connectivity graph may describe that two agent profiles are deemed to have had indirect interactions even though they have not likely had direct interactions because the two agent profiles have each had direct substantial interactions with a common third agent profile. Thus, in some embodiments, the interactions described by a connectivity graph may include substantial indirect interactions as well as substantial direct interactions between a group of individuals, where the significance of inter-agent interactions between two or more agent profiles may be determined based at least in part on estimated disease propagation requirements of a target condition/disease/virus.

In some embodiments, call detail records provide an efficient way of tracking geographical interactions without requiring a significant number of members to install an application. For example, a phone network can centrally sense the connected cell towers for all members of their network with high frequency and use the derived data to generate agent activity data. In some embodiments, a cellular cell network provider could use their contact details to recommend members to get tested (via text for example), and the members can respond to the text with their test outcomes, which will enable the provider to update the models and decide upon the next members to contact.

In some embodiments, individual/member metadata can provide important insights about member connectivity. For example, individuals in the same family policy may be very closely connected on the connectivity graph, individuals in the same work group scheme may be somewhat closely connected on the connectivity graph, individuals with medical claims submitted for the same hospital in the same period of time (and even for the same procedure) may be closely connected on the graph, and/or individuals that share social practices such belonging to same church, practicing at some religious institution, offering lessons by visiting houses in some community may be loosely connected on the connectivity graph.

At step/operation 402, the predictive data analysis computing entity 106 determines, based at least in part on the connectivity graph, a plurality of monitored agent clusters, where each monitored agent cluster includes an interactive subset of the plurality of monitored agent profiles. In general, a monitored agent cluster describes a group of monitored agent profiles deemed to have significant (e.g., above-threshold) interactions between them. Monitored agent clusters may be determined based at least in part on graph concentrations of monitored agents by location over time. For example, a monitored agent cluster may describe a group of monitored agent profiles that are deemed to have high levels of interactions among them. As another example, a monitored agent cluster may describe a group of monitored agent profiles that have significant contemporaneous interactions with a common path/location. In some embodiments, monitored agent clusters are determined based at least in part on agent groupings, where the agent groupings may be determined based at least in part on common associations with most utilized clusters or utilize subsets of agents that represent the entirety of clusters, and where the noted common associations may for example be determined in accordance with travel data (including public transportation data), traffic hotspot data, transactional data, direct contact data, facility utilization data, and/or the like.

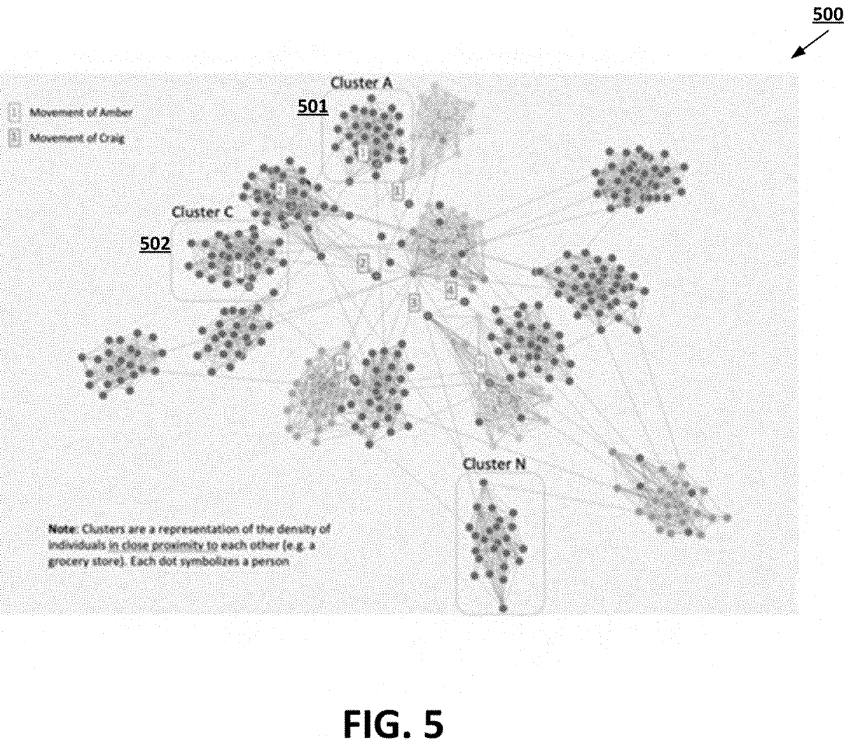

An operational example of generating monitored agent clusters is depicted in FIG. 5. As depicted in FIG. 5, the connectivity graph 500 describes inter-agent interactions among a group of monitored agent profiles, where the monitored agent profiles are depicted via nodes of the connectivity graph 500 and the inter-agent interactions/connections among the group of monitored agent profiles are depicted via edges of the connectivity graph. As further depicted in FIG. 5, the predictive data analysis computing entity 106 has processed the connectivity graph 500 to detect, within the connectivity graph 500, one or more monitored agent clusters, such as the monitored agent cluster 501 and the monitored agent cluster 502.

Returning to FIG. 4, at step/operation 403, the predictive data analysis computing entity 106 determines a per-agent risk score for each monitored agent profile of the plurality of monitored agent profiles. In general, a per-agent risk score may describe a likelihood that a corresponding monitored agent profile suffers from a target condition/disease/virus. The per-agent risk score for a corresponding monitored agent profile may be determined based at least in part on the historical test outcome data for the monitored agent profile and/or the interactivity data for the monitored agent profile, where the historical test outcome data may describe whether the monitored agent profile has tested positive within a recent time period (e.g., where the recent time period may be determined based at least in part on an antibody strength period of the target condition/disease virus), and where the interactivity data may describe a level of interaction/connection of the monitored agent profile with one or more other monitored agent profiles and/or one or more monitored agent clusters. For example, in some embodiments, the occurrence of any of the following conditions may lead to an increase in the per-agent risk score for a monitored agent profile: (i) detection of visitation of a medical provider location with high infection prevalence by the monitored agent profile as described by the agent activity data for the monitored agent profile, (ii) detection of visitation of a location with high infection prevalence by the monitored agent profile as described by the agent activity data for the monitored agent profile, (iii) detection of connection (e.g., direct physical proximity) of the monitored agent profile with another agent profile deemed infected profile as described by the agent activity data for the monitored agent profile, (iv) detection of utilization of public transportation by the monitored agent profile as described by the agent activity data for the monitored agent profile, (v) detection of presence of the monitored agent profile within a predefined proximity of a travel hotspot as described by the agent activity data for the monitored agent profile, and (vi) diagnosis of the monitored agent profile as infected (which may, in some embodiments, set the per-agent risk score for the monitored agent profile to a maximal risk score value, such as a risk probability score value of one). As another example, in some embodiments, a negative test result for the monitored agent profile may decrease the per-agent risk score for the monitored agent profile.

In some embodiments, to generate the per-agent risk score for a target agent profile, the predictive data analysis computing entity 106 first generates a graph embedding for the target agent profile based at least in part on the connectivity graph. The graph embedding may describe one or more interaction intensity measures of a corresponding target agent profile as determined based at least in part on a connectivity graph that describes the interactions/connections of the corresponding target agent profile, where the interaction intensity measures may be defined/articulated with respect to a multi-dimensional embedding space. For example, a particular multi-dimensional embedding space may have a first dimension that describes an intensity of interaction/connection of monitored target agent profiles with infected monitored target agent profiles and/or with monitored target agent profiles having above-threshold per-agent risk scores, a second dimension describing an intensity of association of monitored target agent profiles with monitored agent clusters deemed to have an above-threshold number/ratio of infected monitored target agent profiles and/or with monitored agent clusters deemed to have an above-threshold number of monitored target agent profiles having above-threshold per-agent risk scores, a third dimension describing interaction intensity of monitored target agent profiles with traffic hotspots, and/or the like. In the noted example, the graph embedding for a particular monitored agent profile may be a vector that includes a first vector value describing an intensity of interaction/connection of the particular monitored target agent profile with infected monitored target agent profiles and/or with monitored target agent profiles having above-threshold per-agent risk scores, a second vector value describing an intensity of association of the particular monitored target agent profile with monitored agent clusters deemed to have an above-threshold number/ratio of infected monitored target agent profiles and/or with monitored agent clusters deemed to have an above-threshold number of monitored target agent profiles having above-threshold per-agent risk scores, a third vector value describing the interaction intensity of the particular monitored target agent profile with traffic hotspots, and/or the like. In some embodiments, to generate graph embeddings for a group of monitored agent profiles, a computing entity may process a connectivity graph for the group of monitored agent profiles using one or more graph processing algorithms, such as a random walk graph processing algorithm, a DeepWalk graph processing algorithm, a Node2Vec graph processing algorithm, a Graph2Vec graph processing algorithm, a Graph Embedding with Self Clustering (GEMSEC) graph processing algorithm, and/or the like.

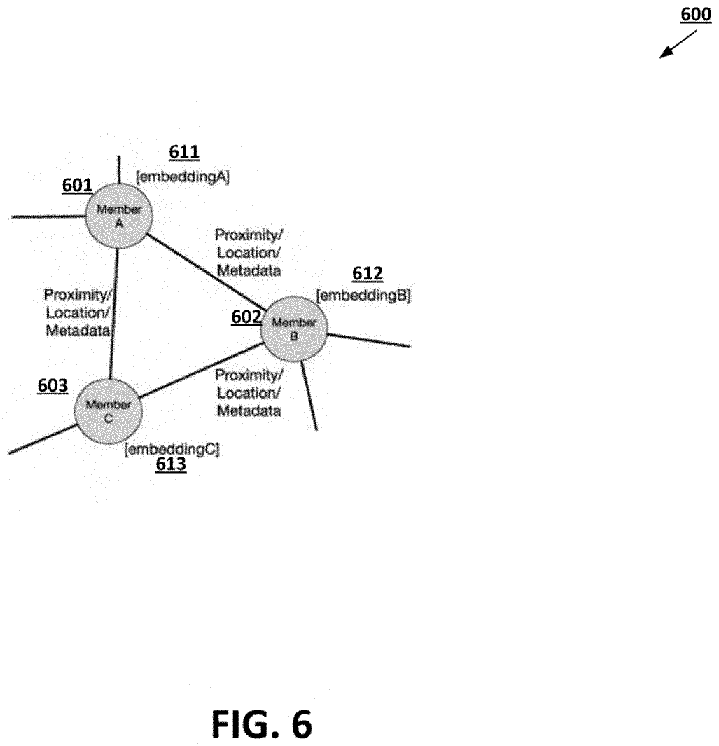

An operational example of generating graph embeddings for three monitored agent profiles is depicted in FIG. 6. As depicted in FIG. 6, each of the three monitored agent profiles depicted via the nodes of the connectivity graph segment 600 is associated with a graph embedding. Thus, the monitored agent profile 601 is associated with the graph embedding 611, the monitored agent profile 602 is associated with the graph embedding 612, and the monitored agent profile 603 is associated with the graph embedding 613. As further depicted in FIG. 6, the edges of the connectivity graph segment 600 may also include interaction/connection metadata (such as proximity metadata, location metadata, and other metadata) describing interactions/connections between the monitored agent profiles. For example, the edge between two monitored agent profile that have been connected because of their physical co-location may describe properties of the corresponding physical location. As another example, the edge between two monitored agent profile that have been connected because of their common usage of a particular facility such as a public transportation facility may describe properties of the particular facility.

Returning to FIG. 4, at step/operation 404, the predictive data analysis computing entity 106 utilizes a test optimization policy to determine a predefined number of target agent profiles of the plurality of monitored agent profiles. In general, the test optimization policy may describe one or more desired utility objectives for selecting target agent profiles, where a target agent profile is a target agent profile that has been selected for testing and whose testing outcome has been predicted to provide significant insights that increase reliability of inferred population-wide per-agent risk scores across an overall population of monitored agent profiles. Examples of objectives for the test optimization policy are described below; however, a person of ordinary skill in the relevant technology will recognize that other such test optimization policy objectives may be desired/recommended. Moreover, when having more than one objective for selecting target agent profiles, the test optimization policy may specify guidelines/operations that are configured to define a tradeoff policy for balancing the objectives against each other, such as weights for each objective and/or operations configured to construct a multi-dimensional optimization measure that can then be optimized using a numerical optimization method in order to select a group of target agent profiles based at least in part on the various test optimization policy objectives.

Thus, as described above, a test optimization policy may be characterized by one or more objectives. An example test optimization policy objective is a cluster maximization objective that is configured to recommend selecting the one or more target agent profiles in a manner that maximizes a count of a related subset of the plurality of monitored agent clusters that are associated with the one or more target agent profiles. In other words, in accordance with the cluster maximization objective, the predictive data analysis computing entity 106 should maximize the number of tested monitored agent clusters, where a monitored agent cluster is deemed tested if at least one monitored agent profile in the interactive subset for the monitored agent cluster (e.g., at least one monitored agent profile that is deemed to be associated with the monitored agent cluster) is selected as a target agent profile. For example, if the cluster maximization objective is the sole objective for a test optimization policy, and further if a predictive data analysis computing entity 106 is configured to select three target agent profiles, and further if there are a total of four monitored agent clusters, the predictive data analysis computing entity 106 may apply the test optimization policy to select at least one monitored agent profile from each of three of the four monitored agent clusters. As another example, if the cluster maximization objective is the sole objective for a test optimization policy, and further if a predictive data analysis computing entity 106 is configured to select five target agent profiles, and further if there are a total of four monitored agent clusters, the predictive data analysis computing entity 106 may apply the test optimization policy to select at least one monitored agent profile from each of the four monitored agent clusters.

Another example of a test optimization policy objective is an exploration-exploitation policy. In some embodiments, the exploitation-exploitation objective is configured to recommend selecting the target agent profiles from an exploration subset of the plurality of monitored agent profiles and an exploitation subset of the plurality of monitored agent profiles, where the exploration subset of the plurality of monitored agent profiles comprises a low risk cluster subset of the plurality of monitored agent profiles that are associated with a low score subset of the plurality of monitored agent clusters having a low per-cluster risk score, and the exploitation subset of subset of the plurality of monitored agent profiles comprises a high risk cluster subset of the plurality of monitored agent profiles that are associated with a high score subset of the plurality of monitored agent clusters having a high per-cluster risk score. For example, if the exploration-exploitation objective is the sole objective for a test optimization policy, and if the exploration-exploitation objective requires selecting forty percent of target agent profiles from the exploration subset and sixty percent of target agent profiles from the exploitation subset, and further if a predictive data analysis computing entity 106 is configured to select ten target agent profiles, then the predictive data analysis computing entity 106 may apply the test optimization policy to select four target agent profiles from the exploitation subset and six target agent profiles from the exploitation subset.

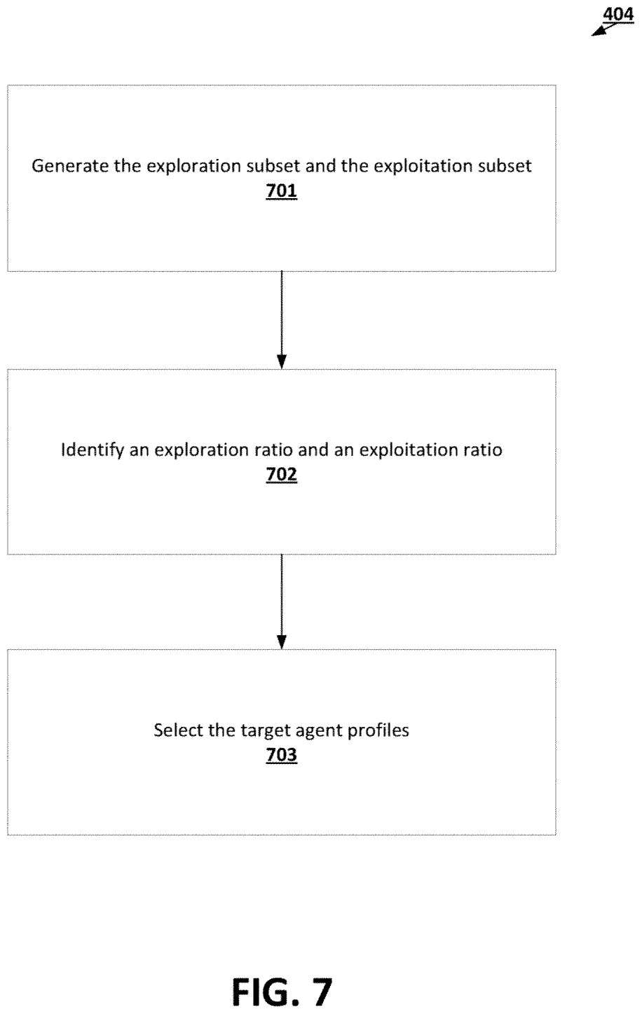

In some embodiments, performing step/operation 404 in accordance with a test optimization policy that is characterized solely by an exploration-exploitation objective is described via the process of FIG. 7. However, a person of ordinary skill in the relevant technology will recognize that a test optimization policy may in some embodiments be associated with one or more test optimization policy objectives in addition to the exploration-exploitation objective.

The process depicted in FIG. 7 begins at step/operation 701 when the predictive data analysis computing entity 106 generates the exploration subset of the plurality of monitored agent profiles and the exploitation subset of the plurality of monitored agent profiles. Both the exploration subset and the exploitation subset are defined with respect to per-cluster risk scores, which are described in greater detail below.

A per-cluster risk score describes a relative measure of estimated prevalence of a target condition/disease/virus among a corresponding monitored agent cluster. The per-cluster risk score for a corresponding monitored agent cluster may be determined based at least in part on the per-agent risk score for each monitored agent profile that is in the interactive subset for the corresponding monitored agent cluster, as well as optionally any other information about susceptibility of the corresponding monitored agent cluster to spreading a disease (such as, for example, information about how much of a traffic hotspot a location associated with the corresponding monitored agent cluster is). For example, in some embodiments, given a monitored agent cluster that is associated with one hundred monitored target agents, the per-cluster risk score for the monitored agent cluster may be determined based at least in part on each per-agent risk score for each of the one hundred monitored agent profiles that are in the interaction subset for the monitored agent cluster. In some embodiments, per-cluster risk scores for a cluster of monitored agent profiles can be used to determine an exploration subset of the group of monitored agent profiles and an exploration subset of the group of monitored agent profiles, where the exploration subset of the group of monitored agent profiles may describe each monitored agent profile in the group of monitored agent profiles that is in the interaction subset for a low score subset of the group of monitored agent clusters having a low (e.g., below a lower threshold, lower-bound outlier, and/or the like) per-cluster risk score, and where the exploitation subset of the group of monitored agent profiles may describe each monitored agent profile in the group of monitored agent profiles that is in the interaction subset for a high score subset of the group of monitored agent clusters having a high (e.g., above a lower threshold, an upper-bound outlier, and/or the like) per-cluster risk score.

At step/operation 702, the predictive data analysis computing entity 106 determines an exploration ratio described by the exploration-exploitation objective and an exploitation ratio described by the exploration-exploitation objective. The exploration ratio may describe a relative significance of selecting target agent profiles from the exploration subset of the plurality of monitored agent profiles (e.g., a desired ratio of target agent profiles that are selected from the exploration subset), and the exploitation ratio may describe a relative significance of selecting target agent profiles from the exploitation subset of the plurality of monitored agent profiles (e.g., a desired ratio of target agent profiles that are selected from the exploitation subset). For example, the exploration ratio may be 0.7 or 70 percent, and the exploitation ratio may be 0.3 or 30 percent.

At step/operation 703, the predictive data analysis computing entity 106 selects the target agent profiles based at least in part on the exploration subset, the exploitation subset, the exploration ratio, and the exploitation ratio. In some embodiments, the predictive data analysis computing entity 106 selects (e.g., randomly, randomly in accordance with a distribution of per-agent clusters for the monitored agent profiles in the exploitation subset) a desired number of target agent profiles from the exploitation subset, where the desired number may be determined in accordance with the exploitation ratio. In some embodiments, the predictive data analysis computing entity 106 selects (e.g., randomly, randomly in accordance with a distribution of per-agent clusters for the monitored agent profiles in the exploration subset) a desired number of target agent profiles from the exploration subset, where the desired number may be determined in accordance with the exploration ratio. For example, if the exploration-exploitation objective is the sole objective for a test optimization policy, and if the exploration ratio recommends selecting forty percent of target agent profiles from the exploration subset and the exploitation ratio recommends selecting sixty percent of target agent profiles from the exploitation subset, and further if the predictive data analysis computing entity 106 is configured to select ten target agent profiles, then the predictive data analysis computing entity 106 may apply the test optimization policy to select four target agent profiles from the exploitation subset and six target agent profiles from the exploitation subset.

Returning to FIG. 4, another example of a test optimization policy objective is an agent cluster connectivity maximization objective, which may be a test optimization policy objective that is configured to recommend selecting target agent profiles based at least in part on a high connectivity subset of the plurality of the plurality of monitored agent profiles having a high cluster connectivity score. The goal of an agent cluster connectivity maximization objective may be to test individuals that have the highest levels of interactions across various clusters and are thus likely to, if infected, infect a higher number of individuals in a higher number of clusters. An example of a person that may be selected according to an agent cluster connectivity maximization objective is a person who is a frequent shopper, a frequent gym participant, and a frequent public transportation user.

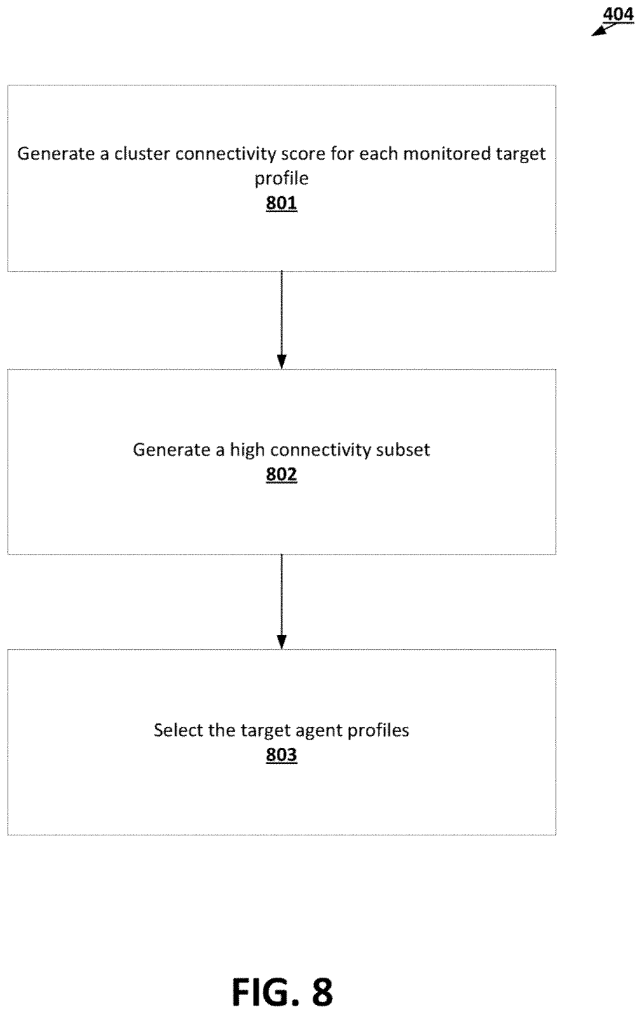

In some embodiments, performing step/operation 404 in accordance with a test optimization policy that is characterized solely by an agent cluster connectivity maximization objective is described via the process of FIG. 8. However, a person of ordinary skill in the relevant technology will recognize that a test optimization policy may in some embodiments be associated with one or more test optimization policy objectives in addition to the agent cluster connectivity maximization objective.

The process depicted in FIG. 8 begins at step/operation 801 when the predictive data analysis computing entity 106 generates a cluster connectivity score for each monitored agent profile of the plurality of monitored agent profiles. The cluster connectivity score for a particular monitored agent profile may describe a measure of a count of monitored agent clusters that the particular monitored agent profile has been in contact with. Thus, accordingly, an example of a person that may have a relatively high cluster connectivity score may be an individual who is a frequent shopper, a frequent gym participant, and a frequent public transportation user.

At step/operation 802, the predictive data analysis computing entity 106 determines a high connectivity subset of the plurality of the plurality of monitored agent profiles having a high cluster connectivity score. For example, the predictive data analysis computing entity 106 may select a threshold number of the plurality of monitored agent profiles having the highest cluster connectivity score as the high connectivity subset. As another example, the predictive data analysis computing entity 106 may select a threshold ratio of the plurality of monitored agent profiles having the highest cluster connectivity score as the high connectivity subset. As yet another example, the predictive data analysis computing entity 106 may select each monitored agent profile having an above-threshold cluster connectivity score as a member of the high connectivity subset.

At step/operation 803, the predictive data analysis computing entity 106 selects the target agent profiles from the high connectivity subset. In some embodiments, the predictive data analysis computing entity 106 selects (e.g., randomly, randomly in accordance with a distribution of cluster connectivity scores for the monitored agent profiles in the high connectivity subset, and/or the like) the predefined number of individuals from the high connectivity subset as the target agent profiles.

Returning to FIG. 4, other examples of test optimization policy objectives are described herein. In accordance with one exemplary test optimization policy objective, two or more target agent profiles are selected from more popular monitored agent clusters (i.e., monitored agent clusters having more monitored agent profiles associated with them) in order to break down the more popular monitored agent clusters into sub-clusters. In this way, the predictive data analysis computing entity 106 can impose a degree of granularity on monitored agent clusters that increases the predictive value of computations performed using those monitored agent clusters. In accordance with another exemplary test optimization policy objective, infected/high-risk-score monitored agent profiles are contact traced via testing, which in turn incentivizes testing monitored agent profiles that have had been physical proximate to, have been in contact to, and/or have used common facilities with infected/high-risk-score monitored agent profiles.

As discussed above, at step/operation 404, the predictive data analysis computing entity 106 selects a predefined number of target agent profiles from the plurality of monitored agent profiles. In some embodiments, the predefined number is determined based at least in part on a test availability hyper-parameter, which may describe an available number of tests for a particular target condition/disease/virus at a point in time. In some embodiments, the predefined number may be selected in accordance with a test optimization policy that is configured to maximize an expected predictive utility of tests performed on members of an overall population in accordance with the constraints imposed by the availability of tests as described by the test availability parameter. Such constrained optimization features may be specially beneficial in deciding test administration during a pandemic.

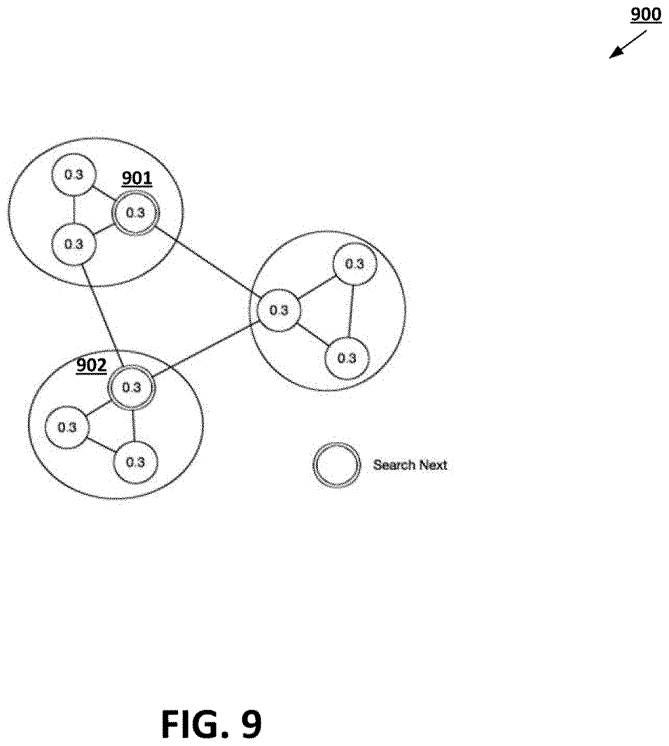

An operational example of selecting target agent profiles is depicted in FIG. 9. As depicted in FIG. 9, the connectivity graph 900 includes nine monitored agent profiles as well as three monitored agent clusters. After applying a test optimization policy, the predictive data analysis computing entity 106 selects two target agent profiles (i.e., monitored agent profile 901 and the monitored agent profile 902), where the particular count of the selected target agent profiles (i.e., the count of two) may be determined by the test availability hyper-parameter for the connectivity graph 900.

Returning to FIG. 4, at step/operation 405, the predictive data analysis computing entity 106 receives test result data for the target agent profiles. In some embodiments, the predictive data analysis computing entity 106 administers the tests for the target agent profiles and generates the tests result data. In some embodiments, the predictive data analysis computing entity 106 enables an external computing entity 102 to administer the tests for the target agent profiles and receives the test result data from the external computing entity 102. In some embodiments, the predictive data analysis computing entity 106 transmits data describing the target agent profiles to an external computing entity 102 and receives and receives the test result data from the external computing entity 102.

At step/operation 406, the predictive data analysis computing entity 106 updates the per-agent risk scores based at least in part on the test result data for the target agent profiles. For example, if the per-agent risk score for a particular target agent profile is positive, the predictive data analysis computing entity 106 may modify the per-agent risk score for the particular target agent profile to describe a maximal per-agent risk score (e.g., a maximal per-agent risk score of one).

As another example, if the per-agent risk score for a particular target agent profile is negative, the predictive data analysis computing entity 106 may generate an updated per-agent risk score for the target agent profile based at least in part on the per-agent risk score for the target agent profile and a false negative risk score and modify the per-agent risk score for the particular target agent profile to describe the updated per-agent risk score. In some embodiments, the false negative risk score describes a likelihood that a target agent profile will have a negative test result despite being infected, e.g., may be equal to the value of p(negative test result disease). In some embodiments, given a negative test result for a target agent profile, the predictive data analysis computing entity 106 may compute the modified per-agent risk score for the target agent profile in accordance with the operations of the below equation:

$$p ( disease \vert negative test result ) = {π}_{j} \frac{( 1 - p )}{( 1 - p {π}_{j} )} \qquad Equation 1$$

In Equation 1, πⱼ is the existing value of the per-agent risk score for the target agent profile (i.e., the prior per-agent risk score that was available before any testing data was received) and p is the false negative risk score (e.g., p(negative test result disease)).

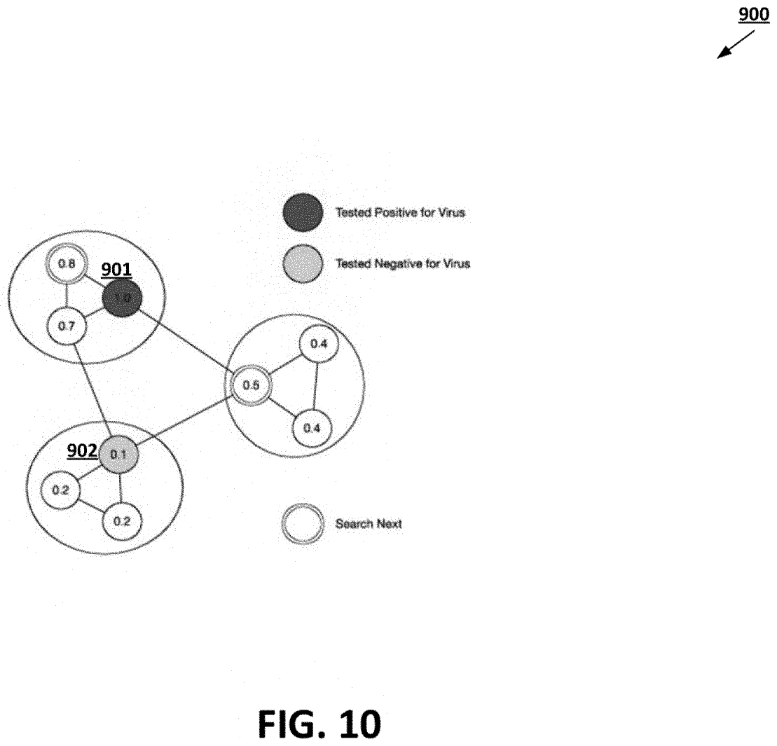

In some embodiments, steps/operations 403-406 may be repeated in an interactive fashion until a terminating condition is reached (e.g., until the end of the testing process, until the end of the pandemic as described by ground-truth measures such as hospital data, and/or the like). For example, as depicted in FIG. 10, in a second iteration, the connectivity graph 900 is updated based at least in part on: (i) a positive test result for the monitored agent profile 901, which will cause the per-agent risk scores for the monitored agent profile 901 to be set to one and the per-agent risk scores for those monitored agent profiles having connections with the monitored agent profile 901 to be increased, and (ii) a negative test result for the monitored agent profile 902, which will cause a reduction in the per-agent risk scores for the monitored agent profile 902 as well as each monitored agent profile that is connected to the monitored agent profile 902 but is not connected to the monitored agent profile 901.

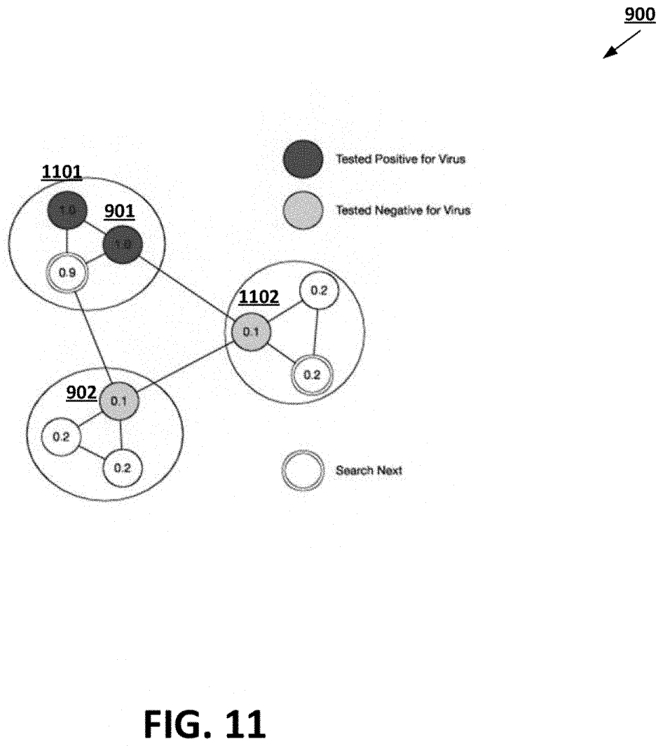

Moreover, as depicted in FIG. 11, the updated per-agent risk scores may be used to select two new target agent profiles, i.e., the monitored agent profile 1103 and the monitored agent profile 1104. As further depicted in FIG. 11, after receiving a positive test result for the monitored agent profile 1103 and a negative test result for the monitored agent profile 1104, the predictive data analysis computing entity 106 has again updated the per-agent risk scores for the monitored agent profiles of the connectivity graph 900 based at least in part on the positive test result for the monitored agent profile 1103 and the negative test result for the monitored agent profile 1104 as well as the previously available information about the positive test result for the monitored agent profile 901 and the negative test result for the monitored agent profile 902.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for probabilistic testing optimization with respect to a plurality of monitored agent profiles, the computer-implemented method comprising:
identifying agent activity data for the plurality of monitored agent profiles;
determining, based at least in part on the agent activity data, a plurality of monitored agent clusters, wherein each monitored agent cluster of the plurality of monitored agent clusters comprises an interactive subset of the plurality of monitored agent profiles;
determining, based at least in part on the agent activity data and the plurality of monitored agent clusters, a per-agent risk score for each monitored agent profile of the plurality of monitored agent profiles;
for each monitored agent cluster of the plurality of monitored agent clusters, determining a per-cluster risk score based at least in part on each per-agent risk score for a monitored agent profile of the plurality of monitored agent profiles that is in the interactive subset for the monitored agent cluster;
selecting a predefined number of target agent profiles of the plurality of monitored agent profiles in accordance with a testing optimization policy, wherein: (i) the test optimization policy is characterized by one or more test optimization policy objectives that comprise an exploitation-exploitation objective, (ii) the exploitation-exploitation objective is configured to recommend selecting the predefined number of target agent profiles from an exploration subset of the plurality of monitored agent profiles and an exploitation subset of the plurality of monitored agent profiles, (iii) the exploration subset of the plurality of monitored agent profiles comprises a low risk cluster subset of the plurality of monitored agent profiles that are associated with a low score subset of the plurality of monitored agent clusters having a low per-cluster risk score, and (iv) the exploitation subset of subset of the plurality of monitored agent profiles comprises a high risk cluster subset of the plurality of monitored agent profiles that are associated with a high score subset of the plurality of monitored agent clusters having a high per-cluster risk score; and
enabling access to output data describing the predefined number of target agent profiles in order to facilitate performing one or more testing operations.

2. The computer-implemented method of claim 1, wherein determining the per-agent risk score for a monitored agent profile of the plurality of monitored agent profiles comprises:
determining one or more cross-agent interactions for the monitored agent profile based at least in part on the agent activity data;
determining one or more historical test outcomes for the monitored agent profiles based at least in part on the agent activity data; and
determining the per-agent risk score based at least in part on the one or more cross-agent interactions and the one or more historical test outcomes.

3. The computer-implemented method of claim 1, wherein:
each monitored agent profile of the plurality of monitored agent profiles is associated with a cluster connectivity score, and
the one or more test optimization policy objectives comprise an agent cluster connectivity maximization objective that is configured to recommend selecting the predefined number of target agent profiles based at least in part on a high connectivity subset of the plurality of the plurality of monitored agent profiles having a high cluster connectivity score.

4. The computer-implemented method of claim 1, wherein selecting the predefined number of target agent profiles comprises:
identifying a plurality of candidate target agent combinations, wherein each candidate target agent combination of the plurality of candidate target agent combinations comprises a predefined number of the plurality of monitored agent profiles that are associated with the target agent combination;
for each candidate target agent combination of the plurality of candidate target agent combinations, determining a combination eligibility score in accordance with the testing optimization policy; and
selecting the predefined number of target agent profiles based at least in part on each combination eligibility score for a candidate target agent combination of the plurality of candidate target agent combinations.

5. The computer-implemented method of claim 4, wherein the predefined number is determined based at least in part on a test availability hyper-parameter.

6. The computer-implemented method of claim 1, wherein performing the one or more testing operations comprises administering a test to each target agent profile of the predefined number of target agent profiles.

7. The computer-implemented method of claim 1, further comprising:
subsequent to enabling access to the output data describing the predefined number of target agent profiles in order to facilitate performing the one or more testing operations:
identifying test outcome data associated with the one or more testing operations, and
updating each per-agent risk score for a target agent profile of the predefined number of target agent profiles based at least in part on the test outcome data.

8. The computer-implemented method of claim 7, wherein updating the per-agent risk score for a target agent profile of the predefined number of target agent profiles comprises:
determining whether a per-agent test outcome for the target agent profile is positive or negative; and
in response to determining that the per-agent test outcome for the target agent profile is positive, modifying the per-agent risk score for the target agent profile to describe a maximal risk score value.

9. The computer-implemented method of claim 8, wherein updating the per-agent risk score for the target agent profile further comprises:
in response to determining that the per-agent test outcome for the target agent profile is negative:
determining an updated per-agent risk score for the target agent profile based at least in part on the per-agent risk score for the target agent profile and a false negative risk score, and
modifying the per-agent risk score for the target agent profile to describe the updated per-agent risk score.

10. The computer-implemented method of claim 1, wherein the one or more test optimization policy objectives comprise a cluster maximization policy that is configured to recommend selecting the predefined number of target agent profiles in a manner that maximizes a count of a related subset of the plurality of monitored agent clusters that are associated with the predefined number of target agent profiles.

11. An apparatus for probabilistic testing optimization with respect to a plurality of monitored agent profiles, the apparatus comprising at least one processor and at least one memory including program code, the at least one memory and the program code configured to, with the processor, cause the apparatus to at least:
identify agent activity data for the plurality of monitored agent profiles;
determine, based at least in part on the agent activity data, a plurality of monitored agent clusters, wherein each monitored agent cluster of the plurality of monitored agent clusters comprises an interactive subset of the plurality of monitored agent profiles;
determine, based at least in part on the agent activity data and the plurality of monitored agent clusters, a per-agent risk score for each monitored agent profile of the plurality of monitored agent profiles;
for each monitored agent cluster of the plurality of monitored agent clusters, determine a per-cluster risk score based at least in part on each per-agent risk score for a monitored agent profile of the plurality of monitored agent profiles that is in the interactive subset for the monitored agent cluster;
select a predefined number of target agent profiles of the plurality of monitored agent profiles in accordance with a testing optimization policy, wherein: (i) the test optimization policy is characterized by one or more test optimization policy objectives that comprise an exploitation-exploitation objective, (ii) the exploitation-exploitation objective is configured to recommend selecting the predefined number of target agent profiles from an exploration subset of the plurality of monitored agent profiles and an exploitation subset of the plurality of monitored agent profiles, (iii) the exploration subset of the plurality of monitored agent profiles comprises a low risk cluster subset of the plurality of monitored agent profiles that are associated with a low score subset of the plurality of monitored agent clusters having a low per-cluster risk score, and (iv) the exploitation subset of subset of the plurality of monitored agent profiles comprises a high risk cluster subset of the plurality of monitored agent profiles that are associated with a high score subset of the plurality of monitored agent clusters having a high per-cluster risk score; and
enable access to output data describing the predefined number of target agent profiles in order to facilitate performing one or more testing operations.

12. The apparatus of claim 11, wherein determining the per-agent risk score for a monitored agent profile of the plurality of monitored agent profiles comprises:
determining one or more cross-agent interactions for the monitored agent profile based at least in part on the agent activity data;
determining one or more historical test outcomes for the monitored agent profiles based at least in part on the agent activity data; and
determining the per-agent risk score based at least in part on the one or more cross-agent interactions and the one or more historical test outcomes.

13. The apparatus of claim 11, wherein:
each monitored agent profile of the plurality of monitored agent profiles is associated with a cluster connectivity score, and
the one or more test optimization policy objectives comprise an agent cluster connectivity maximization objective that is configured to recommend selecting the predefined number of target agent profiles based at least in part on a high connectivity subset of the plurality of the plurality of monitored agent profiles having a high cluster connectivity score.

14. The apparatus of claim 11, wherein selecting the predefined number of target agent profiles comprises:
identifying a plurality of candidate target agent combinations, wherein each candidate target agent combination of the plurality of candidate target agent combinations comprises a predefined number of the plurality of monitored agent profiles that are associated with the target agent combination;
for each candidate target agent combination of the plurality of candidate target agent combinations, determining a combination eligibility score in accordance with the testing optimization policy; and
selecting the predefined number of target agent profiles based at least in part on each combination eligibility score for a candidate target agent combination of the plurality of candidate target agent combinations.

15. The apparatus of claim 11, wherein the one or more test optimization policy objectives comprise a cluster maximization policy that is configured to recommend selecting the predefined number of target agent profiles in a manner that maximizes a count of a related subset of the plurality of monitored agent clusters that are associated with the predefined number of target agent profiles.

16. A computer program product for probabilistic testing optimization with respect to a plurality of monitored agent profiles, the computer program product comprising at least one non-transitory computer-readable storage medium having computer-readable program code portions stored therein, the computer-readable program code portions configured to:
identify agent activity data for the plurality of monitored agent profiles;
determine, based at least in part on the agent activity data, a plurality of monitored agent clusters, wherein each monitored agent cluster of the plurality of monitored agent clusters comprises an interactive subset of the plurality of monitored agent profiles;
determine, based at least in part on the agent activity data and the plurality of monitored agent clusters, a per-agent risk score for each monitored agent profile of the plurality of monitored agent profiles;
for each monitored agent cluster of the plurality of monitored agent clusters, determine a per-cluster risk score based at least in part on each per-agent risk score for a monitored agent profile of the plurality of monitored agent profiles that is in the interactive subset for the monitored agent cluster;
select a predefined number of target agent profiles of the plurality of monitored agent profiles in accordance with a testing optimization policy, wherein: (i) the test optimization policy is characterized by one or more test optimization policy objectives that comprise an exploitation-exploitation objective, (ii) the exploitation-exploitation objective is configured to recommend selecting the predefined number of target agent profiles from an exploration subset of the plurality of monitored agent profiles and an exploitation subset of the plurality of monitored agent profiles, (iii) the exploration subset of the plurality of monitored agent profiles comprises a low risk cluster subset of the plurality of monitored agent profiles that are associated with a low score subset of the plurality of monitored agent clusters having a low per-cluster risk score, and (iv) the exploitation subset of subset of the plurality of monitored agent profiles comprises a high risk cluster subset of the plurality of monitored agent profiles that are associated with a high score subset of the plurality of monitored agent clusters having a high per-cluster risk score; and
enable access to output data describing the predefined number of target agent profiles in order to facilitate performing one or more testing operations.

17. The computer program product of claim 16, wherein determining the per-agent risk score for a monitored agent profile of the plurality of monitored agent profiles comprises:
determining one or more cross-agent interactions for the monitored agent profile based at least in part on the agent activity data;
determining one or more historical test outcomes for the monitored agent profiles based at least in part on the agent activity data; and
determining the per-agent risk score based at least in part on the one or more cross-agent interactions and the one or more historical test outcomes.

18. The computer program product of claim 16, wherein:
each monitored agent profile of the plurality of monitored agent profiles is associated with a cluster connectivity score, and
the one or more test optimization policy objectives comprise an agent cluster connectivity maximization objective that is configured to recommend selecting the predefined number of target agent profiles based at least in part on a high connectivity subset of the plurality of the plurality of monitored agent profiles having a high cluster connectivity score.

19. The computer program product of claim 16, wherein selecting the predefined number of target agent profiles comprises:
identifying a plurality of candidate target agent combinations, wherein each candidate target agent combination of the plurality of candidate target agent combinations comprises a predefined number of the plurality of monitored agent profiles that are associated with the target agent combination;
for each candidate target agent combination of the plurality of candidate target agent combinations, determining a combination eligibility score in accordance with the testing optimization policy; and
selecting the predefined number of target agent profiles based at least in part on each combination eligibility score for a candidate target agent combination of the plurality of candidate target agent combinations.

20. The computer program product of claim 16, wherein the one or more test optimization policy objectives comprise a cluster maximization policy that is configured to recommend selecting the predefined number of target agent profiles in a manner that maximizes a count of a related subset of the plurality of monitored agent clusters that are associated with the predefined number of target agent profiles.
